(19) United States
(12) Patent Application Publication
(10) Pub. No.: US 2018/0351164 A1
(43) Pub. Date: Dec. 6, 2018

(54) MASKING DEVICE FOR USE IN A LITHIUM DEPOSITION PROCESS IN THE MANUFACTURING OF THIN FILM BATTERIES, APPARATUS CONFIGURED FOR A LITHIUM DEPOSITION PROCESS, METHOD FOR MANUFACTURING ELECTRODES OF THIN FILM BATTERIES, AND THIN FILM BATTERY

(71) Applicant: Applied Materials, Inc., Santa Clara, CA (US)

(72) Inventors: Anke HELLMICH, Kahl (DE); Thomas Werner ZILBAUER, Gauting (DE); Jose Manuel DIEGUEZ-CAMPO, Hanau (DE); Stefan KELLER, Mainaschaff (DE); Georg JOST, Munich (DE)

(73) Assignees: Applied Materials, Inc., Santa Clara, CA (US); Applied Materials, Inc., Santa Clara, CA (US)

(21) Appl. No.: 15/570,988

(22) PCT Filed: May 15, 2015
(86) PCT No.: PCT/IB2015/000695

§ 371 Date: Oct. 31, 2017

(51) Int. Cl. H01M 4/1395; H01M 4/04; H01M 4/38; H01M 4/40; H01M 10/052; H01M 6/40

(52) U.S. Cl. CPC H01M 4/1395; H01M 4/0426; H01M 4/382; H01M 10/0585; H01M 10/052; H01M 6/40; H01M 4/405

(57) ABSTRACT

The present disclosure provides a masking device for use in a lithium deposition process in the manufacturing of thin film batteries. The masking device includes a mask portion made of a metal or metal alloy, and one or more openings in the mask portion, wherein the one or more openings are configured to allow particles of a deposition material to pass through the mask portion, and wherein a size of each opening of the one or more openings, is at least 0.5 cm2.

### FIELD

Embodiments of the present disclosure relate to a masking device for use in a lithium deposition process in the manufacturing of thin film batteries, an apparatus configured for a lithium deposition process, a method for manufacturing electrodes of thin film batteries in a lithium deposition process, and a thin film battery. Embodiments of the present disclosure particularly relate to lithium-ion batteries and to masking devices, apparatuses and methods for manufacturing electrodes, such as anodes, of the lithium-ion batteries.

### BACKGROUND

Thin film batteries, such as lithium-ion batteries, are used in a growing number of applications, such as cell phones, notebooks and implantable medical devices. Thin film batteries provide beneficial characteristics with respect to, for example, form factors, cycle life, power capability and safety. Patterned layers such as electrode layers of the thin film batteries can be deposited using a masking device in a deposition process, for example, a lithium deposition process. The masking devices may be corroded by the deposition material used in the deposition process. The corrosion can reduce the lifetime of the masking devices and the masking devices have to be exchanged on a regular basis. Further, the high temperature used for the deposition process can cause damage to the masking device. Moreover, masking devices used in the deposition process are subject to cost considerations.

In view of the above, new masking devices for use in a lithium deposition process in the manufacturing of thin film batteries, apparatuses configured for a lithium deposition process, methods for manufacturing electrodes of thin film batteries in a lithium deposition process, and thin film batteries that overcome at least some of the problems in the art are beneficial. The present disclosure aims at providing masking devices that are less susceptible to corrosion caused by the deposition material. Further, the present disclosure aims at reducing manufacturing costs for the masking devices.

### SUMMARY

In light of the above, a masking device for use in a lithium deposition process in the manufacturing of thin film batteries, an apparatus configured for a lithium deposition process, a method for manufacturing electrodes of thin film batteries in a lithium deposition process, and a thin film battery are provided. Further aspects, benefits, and features of the present disclosure are apparent from the claims, the description, and the accompanying drawings.

According to an aspect of the present disclosure, a masking device for use in a lithium deposition process in the manufacturing of thin film batteries is provided. The masking device includes a mask portion made of a metal or a metal alloy and one or more openings in the mask portion, wherein the one or more openings are configured to allow particles of a deposition material to pass through the mask portion, and wherein a size of each opening of the one or more openings is at least 0.5 cm².

According to another aspect of the present disclosure, a masking device for use in a lithium deposition process in the manufacturing of thin film batteries is provided. The masking device includes a mask portion made of a metal or a metal alloy and one or more openings in the mask portion, wherein the one or more openings are configured to allow particles of a deposition material to pass through the mask portion, and an insulator provided at the mask portion.

According to yet another aspect of the present disclosure, an apparatus configured for a lithium deposition process is provided. The apparatus includes one or more deposition sources, and one or more masking devices according to the embodiments described herein.

According to yet a further aspect of the present disclosure, a method for manufacturing of electrodes of thin film batteries in a lithium deposition process is provided. The method includes a positioning of the masking device according to the embodiments described herein with respect to a substrate, and a depositing of lithium or a lithium alloy on the substrate through the one or more openings in the mask portion to form the electrodes of the thin film batteries.

According to a further aspect of the present disclosure, a thin film battery is provided. The thin film battery includes an electrode that has been deposited using the method of the embodiments described herein.

Embodiments are also directed at apparatuses for carrying out the disclosed methods and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The method includes method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of a masking device for use in a lithium deposition process during the manufacture of thin film batteries according to embodiments described herein;

FIG. 2 shows a schematic view of a thin film battery according to embodiments described herein;

FIGS. 3A, B and C show schematic cross-sectional views of further masking devices for use in a lithium deposition process during the manufacture of thin film batteries according to embodiments described herein;

FIG. 4 shows a schematic cross-sectional view of yet another masking device for use in a lithium deposition process during the manufacture of thin film batteries according to further embodiments described herein;

FIG. 5 shows a flow chart of a method for manufacturing electrodes of thin film batteries in a lithium deposition process according to embodiments described herein; and

FIG. 6 shows a schematic view of a deposition apparatus having a masking device for use in a lithium deposition process during the manufacture of thin film batteries according to embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

During mass production of thin film batteries, patterned electrode layers for forming anodes of the thin film batteries, for example, can be deposited using a masking device in a lithium deposition process. The masking device may be corroded by the lithium used in the deposition process and the lifetime of the masking device can be reduced. Further, the masking devices used in the deposition process are subject to cost considerations.

The present disclosure provides a masking device having a mask portion made of a metal or a metal alloy such as stainless steel. The masking device can withstand lithium and/or high temperatures that might be used in the deposition process. The masking device is reusable. Further, the masking device can be manufactured with reduced costs. Moreover, the metal or metal alloy is less susceptible to damage or breakage than, for example, a ceramic. The masking devices can be used in a lithium deposition process, such as a process for deposition of pure lithium and/or a process for deposition of a lithium alloy or lithium composite. As an example, the lithium deposition process can be a process for deposition of Li, LiTi, or LiTiO.

The embodiments described herein can be utilized for deposition on large area substrates, e.g. for lithium battery manufacturing or electrochromic windows. As an example, a plurality of thin film batteries can be formed on each large area substrate using the masking device for manufacturing of, for example, electrodes such as anodes. According to some embodiments, a large area substrate can be GEN 4.5, which corresponds to about 0.67 m² substrates (0.73×0.92m), GEN 5, which corresponds to about 1.4 m² substrates (1.1 m×1.3 m), GEN 7.5, which corresponds to about 4.29 m² substrates (1.95 m×2.2 m), GEN 8.5, which corresponds to about 5.7 m² substrates (2.2 m×2.5 m), or even GEN 10, which corresponds to about 8.7 m² substrates (2.85 m×3.05 m). Even larger generations such as GEN 11 and GEN 12 and corresponding substrate areas can similarly be implemented.

According to some implementations, the masking devices are configured for use with sub-carriers. As an example, an array of substrates fixed with sub-carriers (e.g., Din A5, A4, or A3) on large carriers (e.g. with a deposition window of Gen 4.5) can be used.

The term “substrate” as used herein shall particularly embrace inflexible substrates, e.g., glass plates and metal plates. However, the present disclosure is not limited thereto and the term “substrate” may also embrace flexible substrates such as a web or a foil.

Although the present embodiments of the masking device are described with reference to the manufacture of thin film batteries, it is to be understood that the masking device could be used in other lithium deposition processes, e.g., in the manufacture of electrochromic windows.

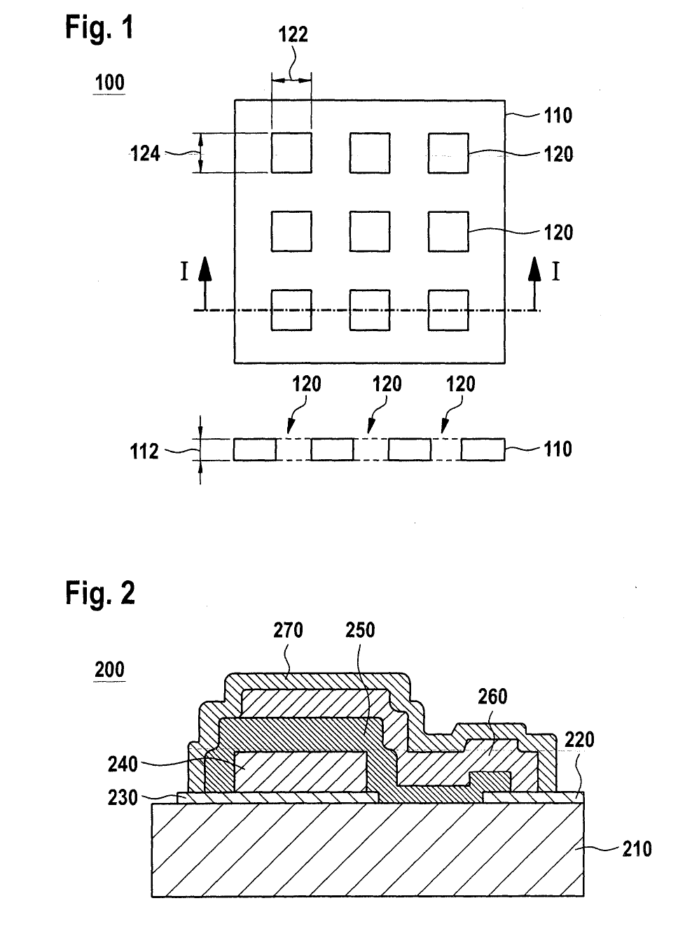

FIG. 1 shows a schematic view of a masking device 100 for use in a lithium deposition process in the manufacture of thin film batteries according to embodiments described herein. The upper section of FIG. 1 shows a plan view of the masking device 100 and the lower section of FIG. 1 shows a cross-sectional side view of the masking device 100 along line I-I. The masking device 100 is configured to mask a substrate (not shown) during the lithium deposition process.

The masking device 100 includes a mask portion 110 made of a metal or metal alloy, and one or more openings 120 in the mask portion 110. The one or more openings 120 are configured to allow particles of a deposition material to pass through the mask portion 110. A size of each opening of the one or more openings 120 is at least 0.5 cm². The masking device 100 having the mask portion 110 made of metal or metal alloy can withstand lithium used in the deposition process and is reusable. Further, the masking device 100 can be manufactured with reduced costs. Moreover, the mask portion 110 made of the metal or metal alloy is less susceptible to damage or breakage when compared to, for example, a ceramic mask.

The one or more openings 120 shown in FIG. 1 have a rectangular shape. However, the present disclosure is not limited thereto. The one or more openings 120 can have any other shape, for example, regular or irregular. The shape of the one or more openings 120 correspond to the shape. of the electrodes of the thin film batteries that are to be deposited on or over the substrate. The one or more openings 120 extend along a thickness direction of the mask portion 110 through the mask portion 110. The one or more openings 120 can also be referred to as “through holes” or “apertures”.

According to some embodiments, which can be combined with other embodiments described herein, the size of each opening of the one or more openings 120 is in the range of 0.5 cm² to 50 cm², specifically in the range of 0.5 cm² to 25 cm², and more specifically in the range of 0.5 cm² to 10 cm². The size of an opening is defined by a circumference or boundary of the opening. As an example, the size of the rectangular shaped openings in FIG. 1 is defined by a first lateral length 122 and a second lateral length 124 of the opening. In some implementations, the size of each opening of the one or more openings 120 is about 1 cm² (e.g., 1 cm×1 cm) or about 4 cm² (e.g., 2 cm×2 cm).

According to some implementations, the mask portion 110 has a thickness 112 of at least 0.1 mm, specifically of at least 0.5 mm, and more specifically of at least 1 mm. As an example, the mask portion 110 has a thickness 112 in the range between about 0.1 mm to about 10 mm, specifically in the range between about 0.1 mm to about 2 mm, and more specifically in the range between about 0.5 mm to about 1 mm. As an example, the mask portion 110 can be a mask body, such as a rigid or inflexible mask body. In some embodiments, the thickness 112 is selected such that the mask portion 110 is substantially rigid or inflexible. In other words, the thickness 112 is selected such that the mask portion 110 is inflexible when compared to, for example, a flexible sheet or mesh. The substantially rigid or inflexible mask portion 110 can improve stability and/or structural integrity of the masking device.

According to some embodiments, which can be combined with other embodiments described herein, the metal or metal alloy of the mask portion 110 is selected from a group consisting of: stainless steel, molybdenum, iron, chromium, aluminum, and any combination thereof. As an example, the stainless steel can include iron and chromium. However, the present disclosure is not limited thereto and any metal or metal alloy could be used that has low or even no susceptibility to being corroded by the deposition material, e.g., lithium.

According to some embodiments, which can be combined with other embodiments described herein, the masking device can be connectable to a substrate carrier. As an example, the substrate carrier can be a frame or a plate that is configured to support the substrate during the deposition process. The masking device can be mounted to the carrier to mask the substrate during the deposition process. The masking device can be mounted to the carrier using at least one of screws, clamps, magnetic means such as magnetic clamps, electrostatic means, and any combination thereof.

FIG. 2 shows a schematic view of a thin film battery 200 according to embodiments described herein. The thin film battery can be used in a number of applications, such as cell phones, notebooks, and implantable medical devices.

The thin film battery 200 includes an electrode that has been deposited using the masking device according to the embodiments described herein. The electrode can, for example, be an anode 260 of the thin film battery 200. In some implementations, the masking device is configured for forming of electrodes of a plurality of thin film batteries. The masking device can have a plurality of openings, wherein, for example, each opening of the plurality of openings could correspond to a respective electrode of a thin film battery of the plurality of thin film batteries. As an example, a plurality of thin film batteries can be formed on a large area substrate using the masking device for forming the anodes of the thin film batteries.

FIG. 2 shows a substrate 210, which may, for example, be glass, ceramic, metal, silicon, mica, a rigid material, a flexible material, plastic, polymer, or any combination thereof. An anode current collector (ACC) 220 and a cathode current collector (CCC) 230 are deposited on or over the substrate 210. A cathode 240 including, for example, LiCoO₂ is deposited over the cathode current collector 230. An electrolyte 250 including, for example, LiPON is deposited at least over the cathode 240. The anode 260 (e.g., pure lithium or a lithium alloy) is deposited using the masking device according to the embodiments described herein. The anode 260 can be formed using, for example, an evaporation process or a sputtering process. As an example, the sputtering process can be conducted using DC sputtering or a pulsed DC sputtering. An encapsulation layer 270 can be deposited to protect the structure of the thin film battery 200.

It is to be understood that when reference is made to the term “over”, i.e. one layer being over the other, it is understood that, starting from the substrate, a first layer is deposited over the substrate, and a further layer, deposited after the first layer, is thus over the first layer and over the substrate. In other words, the term “over” is used to define an order of layers, layer stacks, and/or films wherein the starting point is the substrate. This is irrespective of whether the layer stack is depicted upside down or not.

According to some embodiments, which can be combined with other embodiments described herein, the electrode that is deposited using the masking device of the present disclosure (e.g., the anode 260) can be made of (pure) lithium or a lithium alloy. As an example, the lithium alloy can include lithium and at least one material selected from the group consisting of tin, a semiconductor such as silicon, and any combination thereof. As an example, Li, LiTi, or LiTiO can be deposited in the lithium deposition process. The electrode, e.g., the anode 260 can have a thickness in the range of 0.1 to 50 micrometers, specifically in the range of 1 to 10 micrometers, and can more specifically have a thickness of about 6 micrometers.

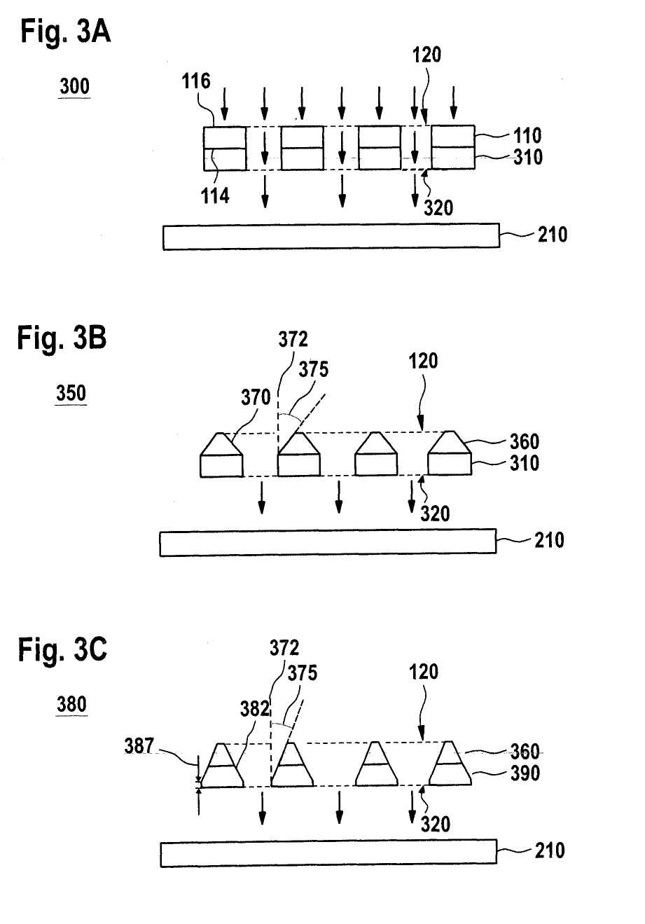

FIG. 3A shows a schematic cross-sectional view of another masking device 300 for use in a lithium deposition process in the manufacturing of thin film batteries according to embodiments described herein. Arrows indicate a deposition material provided by a deposition source (not shown). The deposition material, for example lithium or a lithium alloy, passes through the masking device 300 and is deposited on the substrate 210 to form anodes, e.g., electrodes of thin film batteries.

The masking device includes the mask portion 110 made of a metal or a metal alloy, the one or more openings 120 in the mask portion 110, wherein the one or more openings 120 are configured to allow particles of a deposition material to pass through the mask portion 110, and an insulator 310 provided at the mask portion 110. The insulator 310 is provided between the mask portion 110 and the substrate 210.

The insulator 310 reduces or even avoids electric shorts between, for example, thin film batteries or electrodes of the thin film batteries during the manufacturing process. The insulator 310 can be understood as an electrical insulating material. In some implementations, the insulator 310 includes at least one of a ceramic material and Polytetrafluorethylen (Teflon). As an example, the insulator 310 can be a ceramic insulator.

According to some embodiments, which can be combined with other embodiments described herein, the mask portion 110 has a first side 114 and a second side 116. The first side 114 is configured to face the substrate 210 during the lithium deposition process and the second side 116 is configured to face the deposition source (not shown) during the lithium deposition process. The insulator 310 is provided at least at the first side 114 of the mask portion 110. The first side 114 can be a first surface or first surface area of the mask portion 110, and the second side 116 can be a second surface or second surface area of the mask portion 110.

In the example of FIG. 3A, according to some embodiments, the insulator 310 is only provided at the first side 114 of the mask portion 110, and is not provided at the second side 116 of the mask portion 110. The insulator 310 can cover the first side 114 of the mask portion 110. As an example, the insulator 310 can cover at least 50% of the first side 114 (or first surface or first surface area), specifically at least 90% of the first side 114, and more specifically 100% of the first side 114.

In some implementations, the insulator 310 has one or more insulator openings 320 that correspond to the one or more openings 120 in the mask portion 110. As an example, the one or more insulator openings 312 can have a shape and/or a size that substantially corresponds to the shape and/or size of the one or more openings 120 in the mask portion 110. In some implementations, each insulator opening of the one or more insulator openings 320 has a size that is substantially equal to the size of the one or more openings 120 in the mask portion 110. The term “substantially” shall include embodiments where the sizes of the insulator openings 320 and openings in the mask portion 110 are not exactly identical, for example, due to manufacturing tolerances. The tolerances can, for example, be in a range of plus/minus 10% of the size of the opening. Still, the openings are considered to have substantially the same size. In some embodiments, the insulator 310 does not extend into the one or more openings 120 of the mask portion 110.

In other embodiments, at least one (and specifically each) insulator opening of the one or more insulator openings 320 can have a size that is larger than the size of the one or more openings 120 in the mask portion 110. As an example, the insulator 310 is not provided at a portion of the first side 114 (or first surface or first surface area) around the one or more openings 120 in the mask portion 110. The insulator 310 does not cover the portion of the first side 114 around the one or more openings 120 in the mask portion 110. In still other embodiments, at least one (and specifically each) insulator opening of the one or more insulator openings 320 has a size that is smaller than the size of the one or more openings 120 in the mask portion 110.

According to some embodiments, which can be combined with other embodiments described herein, the insulator 310 is provided separately from the mask portion 110. As an example, the insulator 310 and the mask portion 110 can be separate entities. The insulator 310 and the mask portion 110 can be attached to each other using, for example, adhesives and/or mechanical means such as at least one of clamps and screws. Providing the insulator 310 and the mask portion 110 as separate entities allows for a simplified manufacturing of the masking device. Further, the insulator 310 and the mask portion 110 can be exchanged individually, e.g., in case of damage, and maintenance costs are reduced. In some implementations, the insulator 310 and the mask portion 110 can contact each other. The direct contact can improve a protection of the insulator 310 from the deposition material. In other implementations, the insulator 310 and the mask portion 110 can be positioned at a distance from each other so that they are not in direct contact. The insulator 310 and the mask portion 110 can be positioned and/or exchanged individually, facilitating a handling of the masking device.

According to some embodiments, which can be combined with other embodiments described herein, the insulator 310 includes (or consists of) one or more insulators units (not shown), such as two or more insulators units. The two or more insulators units can be stacked on top of each other with the mask portion provided on top of the stack. In some implementations, the one or more insulators units can be one or more insulator plates having the insulator openings provided therein.

The mask portion 110, e.g., a stainless steel mask, can be placed on top of the insulator 310 to protect the insulator 310. As an example, the insulator 310 can be a ceramic mask that may be corroded by the deposition material, e.g., lithium. The mask portion 110 made of a metal or metal alloy can be placed on top of the ceramic mask to protect the ceramic mask, while the ceramic mask provides for an insulating masking material avoiding electric shorts between the thin film batteries during their manufacturing process.

According to some embodiments, which can be combined with other embodiments described herein, the insulator 310 is provided as a coating on the mask portion 110. As an example, the mask portion 110 could at least partially be coated with Polytetrafluorethylen (Teflon) to provide the insulator 310. The masking device can be manufactured with a reduced thickness when the insulator 310 is provided as the coating on the mask portion 110.

FIG. 3B shows a schematic cross-sectional view of another masking device 350 for use in a lithium deposition process in the manufacturing of thin film batteries according to embodiments described herein. The masking device 350 is similar to the masking device 300 shown in the example of FIG. 3A, and the description given with respect to FIG. 3A applies to the embodiment of FIG. 3B.

According to some embodiments, which can be combined with other embodiments described herein, the one or more openings 120 in the mask portion 360 can have slanted or chamfered edges 370. As an example, edge portions of the one or more openings 120 at the second side of the mask portion 360, i.e., the side of the mask portion 360 that is facing towards the deposition source can be slanted or chamfered. The slanted or chamfered edges 370 can be inclined with respect to a reference line 372. In some implementations, the inner side walls of the one or more openings 120 are at least partially inclined with respect to the reference line 372 to provide the slanted or chamfered edges 370. The reference line 372 can be parallel to at least one of a thickness direction of the mask portion 360 and an axis of the one or more openings 120. In some implementations, the reference line 372 can be substantially perpendicular to a surface of the substrate 210 to be coated. In other words, the reference line 372 can be a normal.

In some implementations, a cross section of the one or more openings 120 in a plane parallel to the reference line 372 can at least partially be V-shaped. The V-shape is provided by the slanted or chamfered edges 370. According to some embodiments, an angle 375 of the slanted or chamfered edges 370 with respect to the reference line 372 is at least 10 degrees, specifically at least 30 degrees, and is more specifically at least 45 degrees. The angle 375 can be less than 90 degrees.

In some implementations, each insulator opening of the one or more insulator openings 320 has a size that is substantially equal to or larger than the size of the one or more openings 120 at a side of the mask portion 360 facing the insulator 310. As an example, each insulator opening of the one or more insulator openings 320 has a size that is larger than the size of the one or more openings 120 at the side of the mask portion 360 facing the insulator 310. The mask portion 360 can at least partially overlap the insulator openings 320 while the one or more openings 120 in the mask portion 360 have the slanted or chamfered edges 370 described above.

The slanted or chamfered edges 370 can reduce or even avoid a shading effect caused by the inner side walls of the openings in the mask portion 360 and/or the insulator 310. A thickness uniformity of the material deposited on the substrate 210 can be improved.

FIG. 3C shows a schematic cross-sectional view of another masking device 380 for use in a lithium deposition process in the manufacturing of thin film batteries according to embodiments described herein. The masking device 380 is similar to the masking device 350 shown in the example of FIG. 3B, and the description given with respect to FIG. 3B applies to the embodiment of FIG. 3C.

In the example of FIG. 3C the one or more insulator openings 320 of the insulator 390 have slanted or chamfered edges 382. As an example, edge portions of the one or more insulator openings 320 that are facing away from the substrate 210 can be slanted or chamfered. The slanted or chamfered edges 382 can be inclined with respect to the reference line 372. In some implementations, the inner side walls of the one or more insulator openings 320 are at least partially inclined with respect to the reference line 372 to provide the slanted or chamfered edges 382. The reference line 372 can be parallel to at least one of a thickness direction of the insulator 390 and an axis of the one or more insulator openings 320.

In some implementations, the inner side walls of the one or more insulator openings 320 have an inclined portion (the slanted or chamfered edge 382) and a non-inclined portion 387. The non-inclined portion 387 can be provided at a side of the insulator 390 that is facing towards the substrate 210. The non-inclined portion 387 can be less than 1 mm, and specifically less than 0.5 mm in a thickness direction of the insulator 390.

According to some embodiments, the inner side walls of the one or more openings 120 in the mask portion 360 are at least partially inclined with respect to the reference line 372 as described with reference to FIG. 3B, and the one or more insulator openings 320 of the insulator 390 have slanted or chamfered edges 382. The one or more openings 120 in the mask portion 360 and the one or more insulator. openings 320 have a combined cross section in a plane parallel to the reference line 372 that can at least partially be V-shaped. The angle 375 of the V-shape with respect to the reference line 372 is at least 10 degrees, specifically at least 30 degrees, and is more specifically at least 45 degrees. The angle 375 can be less than 90 degrees.

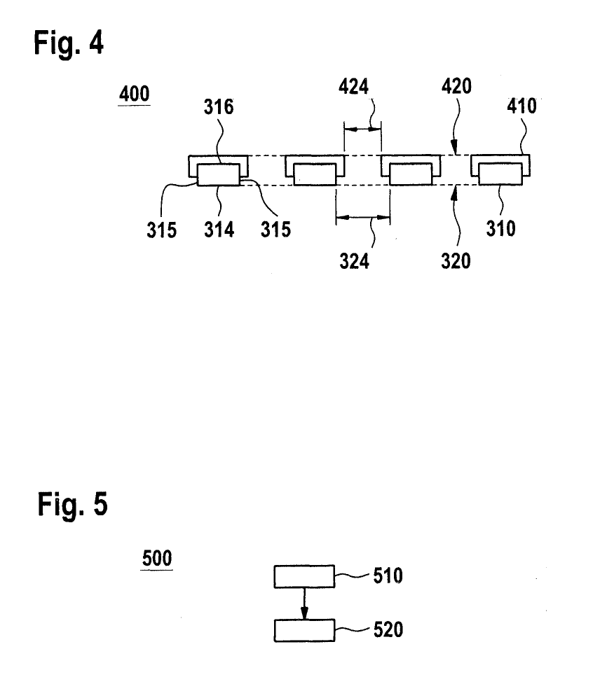

FIG. 4 shows a schematic cross-sectional view of yet another masking device 400 for use in a lithium deposition process in the manufacturing of thin film batteries according to further embodiments described herein. The mask portion 410 is provided as a coating on the insulator 310. The coating allows for an improved protection of the insulator 310 from the deposition material. Further, the masking device can be manufactured with a reduced thickness.

According to some implementations, the mask portion 110 or coating has a thickness 112 in the range between about 10 micrometers to about 0.1 mm, specifically in the range between about 25 micrometers to about 0.1 mm, and more specifically in the range between about 50 micrometers to about 0.1 mm. The thickness 112 can, for example, be about 50 micrometers.

According to some embodiments, which can be combined with other embodiments described herein, the insulator 310 has a first insulator side 314 and a second insulator side 316. The first insulator side 314 is configured to face the substrate (not shown) during the lithium deposition process and the second insulator side 316 is configured to face a deposition source (not shown) during the lithium deposition process. The coating that forms the mask portion 410 is provided at least at the second insulator side 316 of the insulator 310.

As an example, the coating is only provided at the second insulator side 316, and is not provided at the first insulator side 314. The coating can at least partially cover the second insulator side 316. As an example, the coating can cover at least 90% of the second insulator side 316, and more specifically 100% of the second insulator side 316.

In some implementations, the insulator 310 has one or more insulator openings 320. The one or more insulator openings 320 can have side walls 315 defining the one or more insulator openings 320. The mask portion 410 provided by the coating can at least partially extend into the one or more insulator openings 320. As an example, the side walls 315 can be at least partially, and specifically completely, covered with the coating. In some implementations, the coating extends over at least 10% of the thickness of the insulator 310 into the one or more insulator openings 320, specifically over at least 50%, and more specifically over 100%. The coating of the metal or metal alloy that extends into the one or more insulator openings 320 can improve a protection of the insulator 310 from the deposition material. As an example, a corrosion of the ceramic mask (insulator 310) can be reduced or even avoided.

According to some embodiments, each insulator opening of the one or more insulator openings 320 has a size (indicated with reference numeral 324) that is larger than the size of the one or more openings 420 in the mask portion 410 (indicated with reference numeral 424). As an example, the size of the one or more insulator openings 320 can be larger than the size of the one or more openings 420 in the mask portion 410 when the coating (mask portion 410) extends into the one or more insulator openings 320.

FIG. 5 shows a flow chart of a method 500 for manufacturing electrodes of thin film batteries in a lithium deposition process according to embodiments described herein. The electrodes can be anodes.

The method 500 includes a positioning of the masking device in block 510 according to the embodiments described herein with respect to a substrate, and a depositing of lithium or a lithium alloy on the substrate through the one or more openings in the mask portion to form the electrodes of the thin film batteries in block 520. The substrate can be a large area substrate, and a plurality of electrodes of a plurality of thin film batteries can be formed simultaneously.

In some implementations, the lithium deposition process is conducted using sputtering or thermal evaporation. As an example, the sputtering process can be conducted using DC sputtering or a pulsed DC sputtering.

According to embodiments described herein, the method for manufacturing electrodes of thin film batteries in a lithium deposition process can be conducted by means of computer programs, software, computer software products and the interrelated controllers, which can have a CPU, a memory, a user interface, and input and output means being in communication with the corresponding components of the apparatus for processing a large area substrate.

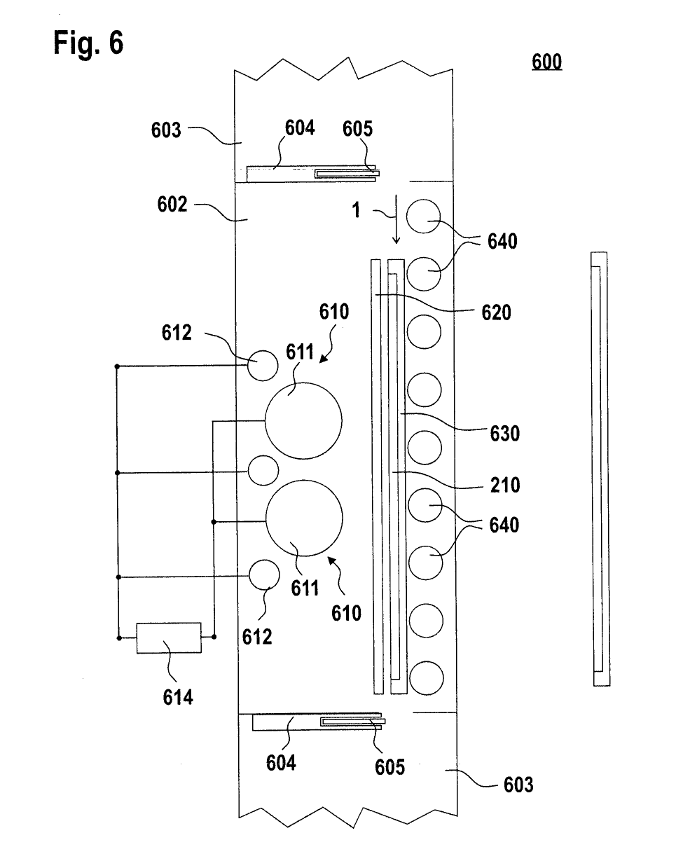

FIG. 6 shows a schematic view of an apparatus 600 having a masking device 620 for use in a lithium deposition process in the manufacturing of thin film batteries. The masking device 620 can be configured according to embodiments described herein.

According to an aspect of the present disclosure, the apparatus 600 includes one or more deposition sources 610, and one or more masking devices 620 according to the embodiments described herein. The masking device 620 is positioned between the substrate 210 and the one or more deposition sources 610. Deposition material, such as lithium, provided by the one or more deposition sources 610 passes through the one or more openings in the mask portion and is deposited on the substrate 210 to form a patterned layer on the substrate 210. The apparatus 600 can be configured for sputter deposition, such as, for example, reactive sputter deposition. Other deposition techniques can be used, such as, for example, thermal evaporation.

DC sputtering can be used to deposit pure lithium or a lithium alloy on the substrate 210 such as a large area substrate. During sputtering, ions are impelled against an exposed surface of a target 611 of the deposition source 610 by providing an electrical potential between the target 611 and an electrode. The ions impacting on the target 611 dislodge atoms of the target 611, which are then deposited on the substrate 210. The target can be a metallic target and can specifically be a lithium target. The process can be conducted in a process atmosphere. According to some embodiments, the process atmosphere can include one or more process gases selected from the group consisting of inert gases such as argon and reactive gases such as oxygen, nitrogen, hydrogen and ammonia (NH3), Ozone (O3), activated gases, and any combination thereof.

Exemplarily, a vacuum chamber 602 for deposition of layers therein is shown. The vacuum chamber 602 can also be referred to as “processing chamber”. As indicated in FIG. 6, further vacuum chambers 603 can be provided adjacent to the vacuum chamber 602. The vacuum chamber 602 can be separated from adjacent further vacuum chambers 603 by a valve having a valve housing 604 and a valve unit 605. After a carrier 630 with the substrate 210 and optionally the masking device 620 thereon is inserted into the vacuum chamber 602, as indicated by arrow 1, the valve unit 605 can be closed. The carrier 630 can be a frame or a plate that is configured to support the substrate 210 during the deposition process. The masking device 620 can be mounted to the carrier 630 to mask the substrate 210 during the deposition process. The masking device 620 can be mounted to the carrier 630 using at least one of screws, clamps, and magnetic means such as magnetic clamps. In other embodiments, the masking device 620 can be mounted in the vacuum chamber 602. In other words, the masking device 620 can be provided separately from the carrier 630.

The atmosphere in the vacuum chambers can be individually controlled by generating a technical vacuum, for example, with vacuum pumps connected to the vacuum chambers, and/or by inserting process gases in a deposition region in the vacuum chamber 602. Within the vacuum chamber 602, rollers 640 are provided in order to transport the carrier 630, having the substrate 210 thereon, into and out of the vacuum chamber 602.

For simplicity, the deposition sources 610 are illustrated to be provided in one vacuum chamber 602. Deposition sources for depositing different layers of a thin film battery, for example, can be provided in different vacuum chambers, for example, the further vacuum chambers 603 adjacent to the vacuum chamber 602. By providing deposition sources or groups of deposition sources 610 in different vacuum chambers, an atmosphere with an appropriate processing gas and/or the appropriate degree of technical vacuum can be provided in each deposition area. As an example, a plurality of vacuum chambers having deposition sources can be provided to form the layers of the thin film batteries, as described with reference to FIG. 2. Although two deposition sources are shown in the example of FIG. 6, any suitable number of deposition sources could be provided. As an example, an array of two or more deposition sources could be provided in the vacuum chamber 602. The array could include three or more, six or more, 10 or more, or even 12 or more deposition sources.

The one or more deposition sources 610 can for example be rotatable cathodes having the targets 611 of the material to be deposited on the substrate 210. The cathodes can be rotatable cathodes with a magnetron therein. Magnetron sputtering can be conducted for depositing of the lithium or lithium alloy on the substrate 210 to form, e.g., electrodes of thin film batteries. The deposition sources 610 are connected to the DC power supply 614 together with anodes 612 collecting electrons during sputtering. According to yet further embodiments, which can be combined with other embodiments described herein, at least one of the one or more cathodes can have its corresponding, individual DC power supply.

As used herein, “magnetron sputtering” refers to sputtering performed using a magnet assembly, that is, a unit capable of generating a magnetic field. Such a magnet assembly can consist of a permanent magnet. This permanent magnet can be arranged within a rotatable target or coupled to a planar target in a manner such that the free electrons are trapped within the generated magnetic field generated below the rotatable target surface. Such a magnet assembly may also be arranged coupled to a planar cathode.

According to some embodiments, the substrate 210 is static or dynamic during deposition of the deposition material. According to embodiments described herein a static deposition process can be provided, e.g., for thin film battery processing. It should be noted that “static deposition processes”, which differ from dynamic deposition processes do not exclude any movement of the substrate as would be appreciated by a skilled person. A static deposition process can include, for example, at least one of the following: a static substrate position during deposition; an oscillating substrate position during deposition; an average substrate position that is essentially constant during deposition; a dithering substrate position during deposition; a wobbling substrate position during deposition; a deposition process for which the cathodes are provided in one vacuum chamber, i.e. a predetermined set of cathodes are provided in the vacuum chamber; a substrate position wherein the vacuum chamber has a sealed atmosphere with respect to neighboring chambers, e.g. by closing valve units separating the vacuum chamber from an adjacent chamber during deposition of the layer; or a combination thereof. A static deposition process can be understood as a deposition process with a static position, a deposition process with an essentially static position, or a deposition process with a partially static position of the substrate. In view of this, a static deposition process, in which the substrate position can in some cases be not fully without any movement during deposition, can still be distinguished from a dynamic deposition process.

The present disclosure provides a masking device having .a mask portion made of a metal or a metal alloy such as stainless steel. The masking device can withstand lithium and/or high temperatures that might be used in the deposition process. The masking device is reusable. Further, the masking device can be manufactured with reduced costs. Moreover, the metal or metal alloy is less susceptible to damage or breakage than, for example, a ceramic.

While the foregoing is directed to embodiments of the disclosure, other and further embodiments of the disclosure may be devised without departing from the basic scope thereof, and the scope thereof is determined by the claims that follow.

1. A masking device for use in a lithium deposition process in the manufacturing of thin film batteries, comprising:
a mask portion made of a metal or a metal alloy; and
one or more openings in the mask portion allowing particles of a deposition material to pass through the mask portion, and a size of each opening of the one or more openings being at least 0.5 cm².

2. The masking device of claim 1, wherein the size of each opening of the one or more openings is in a range of 0.5 cm² to 50 cm².

3. The masking device of claim 1, wherein the masking device forms electrodes of a plurality of thin film batteries.

4. The masking device of claim 1, further including an insulator provided at the mask portion.

5. The masking device of claim 4, wherein the insulator includes at least one of a ceramic material and polytetrafluorethylen.

6. The masking device of claim 4, wherein the mask portion has a first side and a second side, the first side being configured to face a substrate during the lithium deposition process, the second side being configured to face a deposition source during the lithium deposition process, and the insulator being provided at least at the first side of the mask portion.

7. The masking device of claim 4, wherein the insulator has one or more insulator openings that correspond to the one or more openings in the mask portion.

8. The masking device of claim 7, wherein each opening of the one or more insulator openings has a size that is equal to or larger than the size of the one or more openings in the mask portion.

9. The masking device of claim 4, wherein the mask portion and the insulator are provided as separate entities.

10. The masking device of claim 4, wherein the mask portion is provided as a coating on the insulator.

11. The masking device of claim 1, wherein the metal or metal alloy of the mask portion is selected from the group consisting of: stainless steel, molybdenum, aluminum, iron, chromium, and any combination thereof.

12. An apparatus configured for a lithium deposition process, comprising:
one or more deposition sources; and
one or more masking devices for use in a lithium deposition process in the manufacturing of thin film batteries comprising:
a mask portion made of a metal or a metal alloy; and
one or more openings in the mask portion allowing particles of a deposition material to pass through the mask portion, and a size of each opening of the one or more openings being at least 0.5 cm².

13. A method for manufacturing electrodes of thin film batteries in a lithium deposition process, comprising:
positioning the masking device for use in a lithium deposition process in the manufacturing of thin film batteries with respect to a substrate, the masking device comprising:
a mask portion made of a metal or a metal alloy; and
one or more openings in the mask portion allowing particles of a deposition material to pass through the mask portion, and a size of each opening of the one or more openings being at least 0.5 cm²; and
depositing lithium or a lithium alloy on the substrate through the one or more openings in the mask portion to form the electrodes of the thin film batteries.

14. The method of claim 13, wherein the lithium deposition process is conducted using sputtering or thermal evaporation.

15. A thin film battery, including an electrode manufactured using the method for manufacturing electrodes of thin film batteries in a lithium deposition process, the method comprising:
positioning the masking device for use in a lithium deposition process in the manufacturing of thin film batteries with respect to a substrate, the masking device comprising:
a mask portion made of a metal or a metal alloy; and
one or more openings in the mask portion allowing particles of a deposition material to pass through the mask portion, and a size of each opening of the one or more openings being at least 0.5 cm²; and
depositing lithium or a lithium alloy on the substrate through the one or more openings in the mask portion to form the electrodes of the thin film batteries.

16. The thin film battery according to claim 15, wherein the lithium deposition process is conducted using sputtering or thermal evaporation.

17. The apparatus according to claim 12, wherein the size of each opening of the one or more openings is in a range of 0.5 cm² to 50 cm².

18. The apparatus according to claim 12, wherein the masking device forms electrodes of a plurality of thin film batteries.

19. The apparatus according to claim 12, further including an insulator provided at the mask portion.

20. The apparatus according to claim 19, wherein the insulator includes at least one of a ceramic material and polytetrafluorethylene.
